(19) United States
(12) Patent Application Publication
(10) Pub. No.: US 2017/0124580 A1
(43) Pub. Date: May 4, 2017

(54) Methods and Apparatus for Identifying Customer Segments from Transaction Data

(71) Applicant: MasterCard International Incorporated, Purchase, NY (US)

(72) Inventors: Geetika Sharma, Delhi (IN); Amit Gupta, Dwarka (IN); Shikha Goel Mittal, Faridabad (IN)

(21) Appl. No.: 15/340,697

(22) Filed: Nov. 1, 2016

(30) Foreign Application Priority Data
Nov. 2, 2015 (SG) 10201509021U

(51) Int. Cl. G06Q 30/02; G06Q 40/00

(52) U.S. Cl. CPC G06Q 30/0204; G06Q 40/12; G06Q 30/0255

(57) ABSTRACT

A computer implemented method of identifying customer segments from transaction data is provided. The method includes receiving transaction data that includes transaction indications. Each transaction indication includes an indication of a transaction date and a cardholder identifier. The method also includes classifying spending behavior of a cardholder in a first period into classifications from a plurality of classifications and further classifying spending behavior of the cardholder in a second period into classifications from a plurality of classifications. The method also includes comparing the classification of the spend behavior of the cardholder in the first period with the classification of the spend behavior of the cardholder in the second period and associating the cardholder with one of a plurality of customer segments based on a result of the comparison.

### CROSS REFERENCE TO RELATED APPLICATIONS

This application claims the benefit of Singapore Patent Application No. 10201509021U filed Nov. 2, 2015, which is hereby incorporated by reference in its entirety.

### BACKGROUND

The present disclosure relates to a method and system for processing data. In particular, it provides a method and system for identifying customer segments from transaction data.

Issuers of payment cards, such as credit cards, generally wish to retain existing customers or cardholders and identify possible avenues for increasing engagement of these existing customers or cardholders. In order to retain existing customers, the identification of early signs of customer attrition is important. This would allow customers that are at risk to be targeted with marketing to prevent the attrition. Similarly, certain customers may present opportunities for expansion of engagement. Again, if this segment of customers can be identified, then they can be targeted with marketing to increase their engagement.

In both of the scenarios mentioned above, in order to accurately target customers, it is necessary to identify customers in specific segments.

### BRIEF DESCRIPTION

In general terms, the present disclosure proposes a method and apparatus for identifying customer segments from transaction data. The customers' spending behavior in two defined time periods is analyzed. Based on a comparison of the customers' spending behavior in the two periods, the customers are segmented. This analysis may be based on all transactions across all types of spending or may be based on specific spend types. The customers may be, for example, categorized as migrators when their spend has increased between the two periods, detractors when their spend has decreased between the two periods, and passive when there is no change in their spend behavior. This classification allows customers at risk of attrition to be identified and also customers with a likelihood of increasing their engagement to be identified.

According to a first aspect of the present disclosure a computer implemented method for identifying customer segments from transaction data is provided. The method includes receiving, at a customer segment analysis server, transaction data, the transaction data including transaction indications, each transaction indication including an indication of a transaction date and a cardholder identifier, classifying, in a spend behavior classification module of the customer segment analysis server, spending behavior of a cardholder in a first period into classifications from a plurality of classifications by analyzing transactions having a cardholder identifier matching the cardholder and a transaction date within the first period, classifying in the spend behavior classification module of the customer segment analysis server, spending behavior of the cardholder in a second period into classifications from a plurality of classifications by analyzing transactions having a cardholder identifier matching the cardholder and a transaction date within the second period, and comparing, in a customer segmentation module of the customer segment analysis server, the classification of the spend behavior of the cardholder in the first period with the classification of the spend behavior of the cardholder in the second period and associating the cardholder with one of a plurality of customer segments based on a result of the comparison.

In an embodiment, the method further includes identifying, in a spend category identification module of the customer segment analysis server, a spend category associated with each transaction, and wherein classifying spending behavior of the cardholder includes classifying the spend behavior of the cardholder in each of a plurality of spend categories.

In an embodiment, the transaction indications further include a merchant identifier, and wherein identifying a spend category associated with a transaction includes determining a merchant category associated with the merchant corresponding to the merchant identifier and using a mapping of merchant category to spend category to determine the spend category associated with the transaction.

In an embodiment, the spend behavior classifications include ranges of total spend amount in the first and second periods.

In an embodiment, the spend behavior classifications include ranges of number of transactions in the first and second periods.

In an embodiment, the spend behavior classifications include ranges of spend amount in spend categories of the plurality of spend categories in the first and second periods.

In an embodiment, the spend behavior classifications include ranges of number of transactions in spend categories of the plurality of spend categories in the first and second periods.

According to a second aspect, an apparatus for identifying customer segments from transaction data is provided. The apparatus includes a computer processor and a data storage device, the data storage device having a spend behavior classification module, and a customer segmentation module including non-transitory instructions operative by the processor to receive transaction data, the transaction data including transaction indications, each transaction indication including an indication of a transaction date and a cardholder identifier, classify spending behavior of a cardholder in a first period into classifications from a plurality of classifications by analyzing transactions having a cardholder identifier matching the cardholder and a transaction date within the first period, classify spending behavior of the cardholder in a second period into classifications from a plurality of classifications by analyzing transactions having a cardholder identifier matching the cardholder and a transaction date within the second period, and compare the classification of the spend behavior of the cardholder in the first period with the classification of the spend behavior of the cardholder in the second period and associate the cardholder with one of a plurality of customer segments based on a result of the comparison.

In an embodiment, the data storage device further includes a spend category identification module including non-transitory instructions operative by the processor to identify a spend category associated with each transaction and wherein classifying spending behavior of the cardholder includes classifying the spend behavior of the cardholder in each of a plurality of spend categories.

In an embodiment, the transaction indications further include a merchant identifier, and wherein identifying a spend category associated with a transaction includes determining a merchant category associated with the merchant corresponding to the merchant identifier and using a mapping of merchant category to spend category to determine the spend category associated with the transaction.

In an embodiment, the spend behavior classifications include ranges of total spend amount in the first and second periods.

In an embodiment, the spend behavior classifications include ranges of number of transactions in the first and second periods.

In an embodiment, the spend behavior classifications include ranges of spend amount in spend categories of the plurality of spend categories in the first and second periods.

In an embodiment, the spend behavior classifications include ranges of number of transactions in spend categories of the plurality of spend categories in the first and second periods.

According to a yet further aspect, a non-transitory computer-readable medium is provided. The computer-readable medium has stored thereon program instructions for causing at least one processor to perform operations of a method disclosed above.

### BRIEF DESCRIPTION OF THE DRAWINGS

Embodiments of the disclosure will now be described for the sake of non-limiting example only, with reference to the following drawings in which:

FIG. 1a is a block diagram of a data processing system according to an embodiment of the present disclosure,

FIG. 1b is a block diagram illustrating a payment network incorporating a customer segment analysis server according to an embodiment of the present disclosure,

FIG. 2 is a block diagram illustrating a technical architecture of the apparatus according to an embodiment of the present disclosure, and

FIG. 3 is a flowchart illustrating a method of identifying customer segments from transaction data according to an embodiment of the present disclosure.

### DETAILED DESCRIPTION

As used herein, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

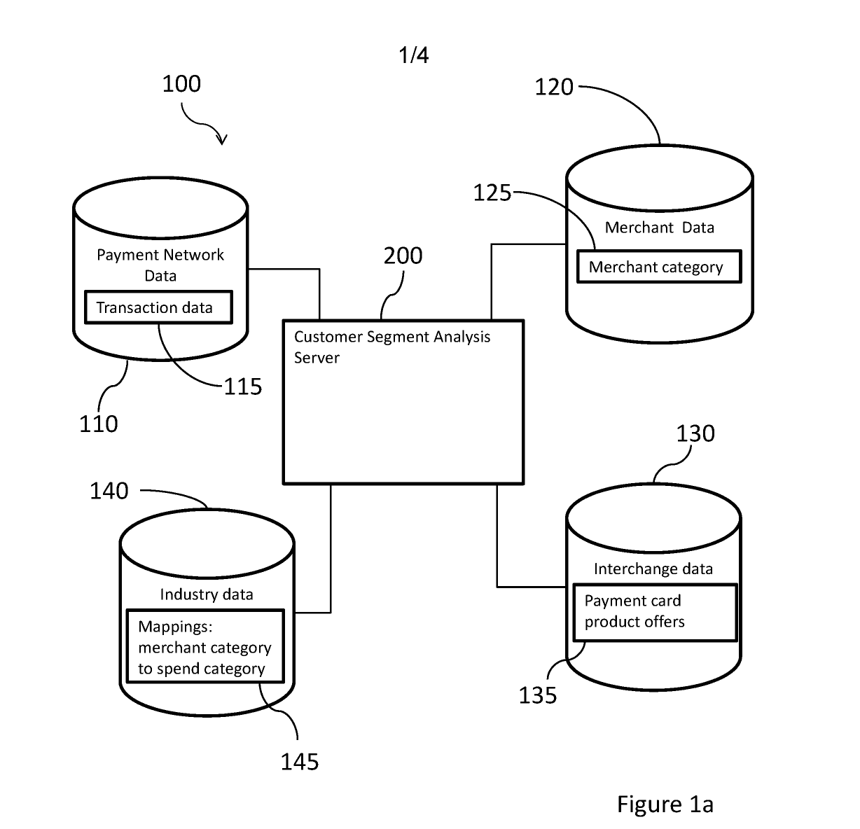

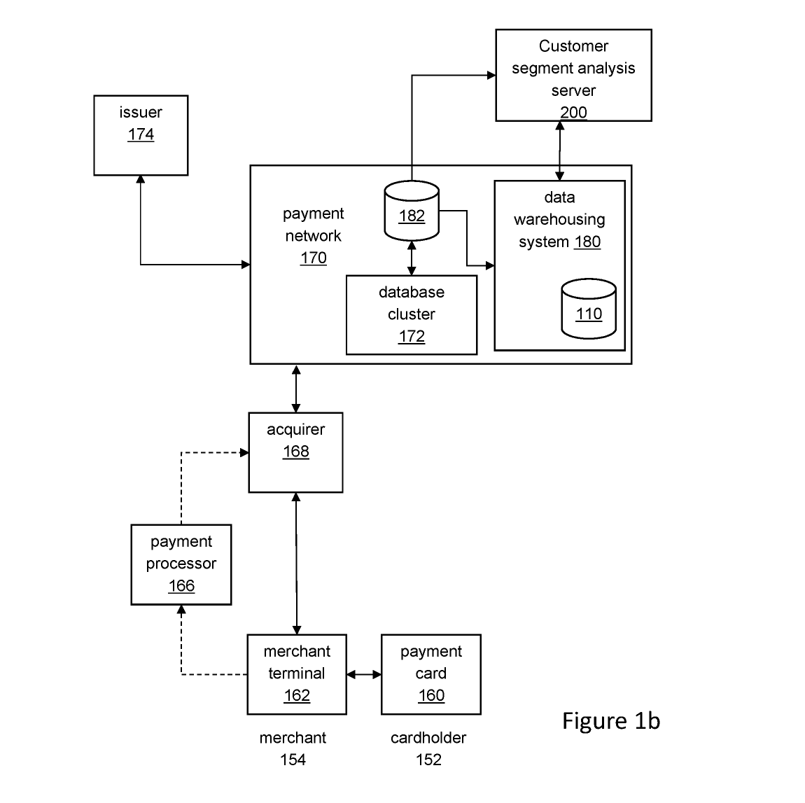

FIG. 1 is a block diagram showing a data processing system according to an embodiment of the present disclosure. The data processing system 100 includes a customer segment analysis server 200. The customer segment analysis server 200 is coupled to a database which stores payment network data 110, a database which stores merchant data 120, a database which stores interchange data 130, and a database which stores industry data 140.

The payment network data 110, the merchant data 120, the interchange data 130 and the industry data 140 may all be resident on different servers. The servers may be either within a single data warehouse or distributed over a plurality of data warehouses. The data processed by the customer segment analysis server 200 may be retrieved from the servers, and cleaned and stored in a data warehouse prior to the analyses being conducted. Alternatively, the demand estimation server 200 may receive the data from servers which may be operated by different providers.

The payment network data 110 includes transaction data 115. The transaction 115 data includes indications of transactions, which indicates information including the time and date of transactions, transaction amount, the card number of a payment card used for the transaction, and the merchant at which the transaction was carried out. The merchant data 120 includes merchant category data 125 which indicates the category of merchants. The merchant data 120 may further include a plurality of fields, such as a merchant doing business as (DBA) short name, a merchant location, and a merchant category code (MCC). The interchange data 130 includes indications of payment card product offers 135. The industry data 140 includes mappings 145 which map merchant categories to spend categories. The spend categories may include categories, such as everyday spend, luxury spend, domestic spend, overseas spend, on-line spend, and off-line spend. The mappings 145 may map certain merchant categories to these spend categories. For example, supermarkets, grocery stores, newsagents, and petrol stations may be mapped to everyday spend.

FIG. 1b shows an example of data processing system which generates the payment network data 110. As shown in FIG. 1b, the customer segment analysis server 200 receives transaction data from a payment network 170, such as the payment network operated by MasterCard.

The payment network 170 acts as an intermediary during a transaction being made by a cardholder 152 using a payment card 160 at a merchant terminal 162 of a merchant 154. In particular, the cardholder 152 may present the payment card 160 to merchant terminal 162 of merchant 164 as payment for goods or services. The merchant terminal 162 may be a point of sale (POS) device, such as a magnetic strip reader, chip reader or contactless payment terminal, or a website having online e-commerce capabilities, for example. A merchant 154 may operate one or a plurality of merchant terminals 162. The merchant terminal 162 communicates with an acquirer computer system 168 of a bank or other institution with which the merchant 154 has an established account, in order to request authorization for the amount of the transaction (sometimes referred to as ticket size) from the acquirer system 168. In some embodiments, if the merchant 154 does not have an account with the acquirer 168, the merchant terminal 162 can be configured to communicate with a third-party payment processor 166 which is authorized by acquirer 168 to perform transaction processing on its behalf, and which does have an account with the acquirer entity.

The acquirer system 168 routes the transaction authorization request from the merchant terminal 162 to computer systems of the payment network 170. The transaction authorization request is then routed by payment network 170 to computer systems of the appropriate issuer institution (e.g., issuer 174) based on information contained in the transaction authorization request. The issuer institution 174 is authorized by payment network 170 to issue payment devices 160 on behalf of customers 152 to perform transactions over the payment network 170. Issuer 174 also provides funding of the transaction to the payment network 170 for transactions that are approved.

The computer systems of the issuer 174 analyze the authorization request to determine the account number submitted by the payment card 160, and based on the account number, determine whether the account is in good standing and whether the transaction amount is covered by the cardholder's account balance or available credit. Based on this, the transaction can be approved or declined, and an authorization response message transmitted from issuer 174 to the payment network 170, which then routes the authorization response message to the acquirer system 178. The acquirer system 178, in turn, sends the authorization response message to merchant terminal 162. If the authorization response message indicates that the transaction is approved, then the account of the merchant 154 (or of the payment processor 166 if appropriate) is credited by the amount of the transaction.

During each authorization request as described in the previous paragraphs, the payment network 170 stores transaction information in a transactions database 110 accessible via a database cluster 172. The database cluster 172 may include one or more physical servers. In some embodiments, the transactions database 110 may be distributed over multiple devices which are in communication with one another over a communications network, such as a local-area or wide-area network. In some embodiments, the transactions database 110 may be in communication with a data warehousing system 180 including a data warehouse database 182 which may store copies of the transaction data, and/or cleaned and/or aggregated data which are transformed versions of the transaction data.

The data warehouse database 182 may also include records relating to individual cardholders, which, for example, may associate demographic information, such as age, gender, number of dependents, and salary range with a card identifier (e.g., a PAN), thereby permitting transaction data to be matched to demographic data. In some embodiments, each transaction record stored in the data warehouse database 182 may already have the matched demographic data stored as part thereof.

Transaction records (or aggregated data derived therefrom) may be directly accessible for the purposes of performing analyses, for example by the customer segment analysis server 200, from transactions database 160. Alternatively, or in addition, the transaction records (or aggregated data derived therefrom) may be accessed (for example, by the customer segment analysis server 200) from the data warehouse database 182. Accessing the transaction records from the data warehouse database 182, instead of the transactions database 236, has the advantage that the load on the transactions database 110 is reduced.

The transaction records may include a plurality of fields, including acquirer identifier/card accepter identifier (the combination of which uniquely defines the merchant), merchant category code (also known as card acceptor business code), that is, an indication of the type of business the merchant is involved in (for example, a gas station), cardholder base currency (i.e., U.S. Dollars, Euros, Yen, etc.), the transaction environment or method being used to conduct the transaction, product specific data, such as SKU line item data, the transaction type; card identifier (e.g., card number), time and date, location (full address and/or GPS data), transaction amount (also referred to herein as ticket size), terminal identifier (e.g., merchant terminal identifier or ATM identifier), and response code (also referred to herein as authorization code). Other fields may be present in each transaction record.

Each terminal identifier may be associated with a merchant 154, for example, in a merchant database of the payment network 170. Typically, a particular merchant 154 will have a plurality of merchant terminal identifiers, corresponding to merchant terminals 162, associated with it.

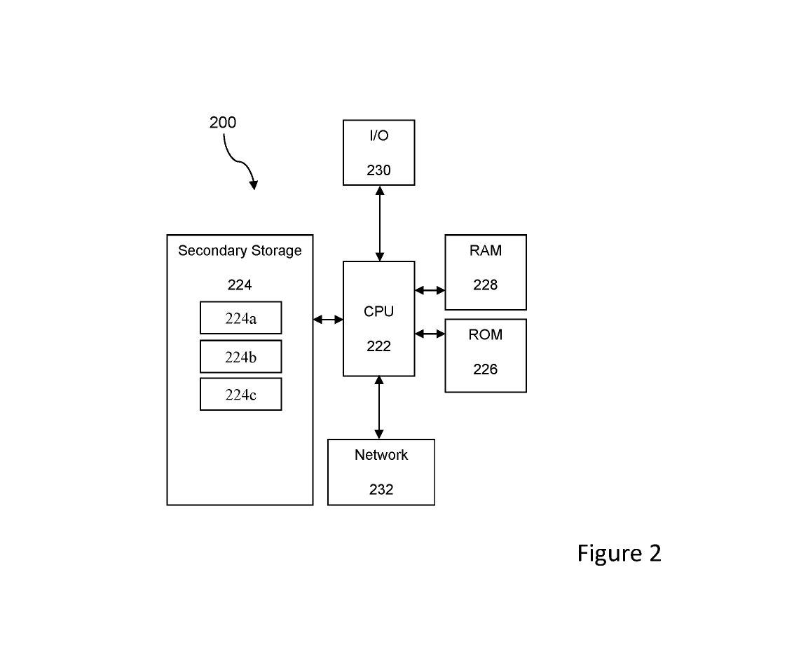

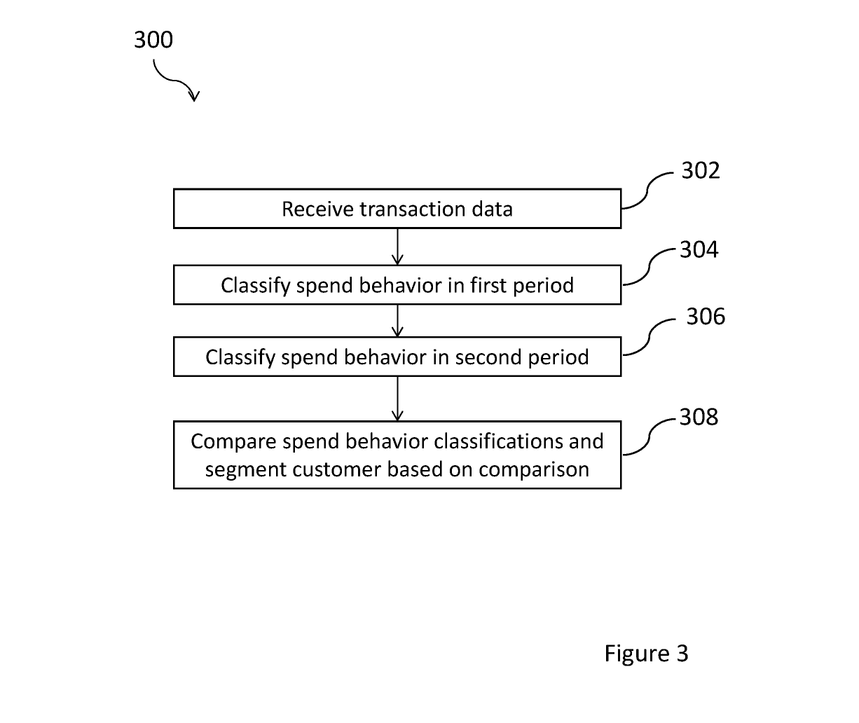

FIG. 2 is a block diagram showing a technical architecture of the server of the customer segment analysis server 200 for performing an exemplary method 300 which is described below with reference to FIG. 3. Typically, the method 300 is implemented by a computer having a data-processing unit. The block diagram as shown in FIG. 2 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further include input/output (I/O) devices 230, and network connectivity devices 232.

The secondary storage 224 typically includes one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a spend category identification module 224a, a spend behavior classification module 224b, and a customer segmentation module 224c including non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers.

In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may provide computing services via a network connection using dynamically scalable computing resources. A cloud computing environment may be established by an enterprise and/or may be hired on an as-needed basis from a third party provider.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 300 will now be described with reference to FIG. 3 in respect of analysis of transactions to identify customer segments from transaction data. It should be noted that enumeration of operations is for purposes of clarity and that the operations need not be performed in the order implied by the enumeration.

In step 302, the customer segment analysis server 200 receives transaction data from the database storing the payment network data 110.

In step 304, the spend behavior classification module 224b of the customer segment analysis server 200 classifies the customer spend behavior for cardholders during a first period into one of a plurality of classifications. Transactions in the transaction data corresponding to a cardholder are identified using the card identifier or card number included in the transaction data.

Transactions within the first period are identified from the transaction date. The first period and the second period may be for example, 3 months, 6 months, or 12 months.

The classification that takes place in step 304 may be on the basis of the total spend amount by the customer within the first period. This spend amount may be categorized into low spend (for example, less than 50 US Dollars), medium spend (for example, 50 to 1000 US Dollars), and high spend (for example, more than 1000 US Dollars).

Alternatively, the classification in that takes place in step 304 may be on the basis of the number of transactions by the customer within the first period. This spend amount may be categorized into low number of transactions (for example, less than 5 transactions), medium number of transactions (for example, 5 to transactions and high number of transactions (for example, more than 10 transactions).

As described above, the classification may be based on all transactions, in an alternative embodiment, the cardholder's spend in each of a number of categories may be classified. The categories may be based on spend type, such as everyday spend, for example, the cardholder's spend on groceries and fuel, and luxury spend, for example, the cardholder's spend on luxury items, such as jewelry. Other possible categories include cash withdrawals using automatic teller machines (ATMs), gambling spend, on-line or off-line spend, domestic and overseas spend. The spend category identification module 224a of the customer segment analysis server 200 may determine the spend category for transactions using the mappings 145 in the industry data 140. This process may involve determining a merchant category for transactions using the merchant category 125 in the merchant data 120 and then determining the spend category using the mappings 145 in the industry data 145.

In step 306, the spend behavior classification module 224b of the customer segment analysis server 200 classifies the customer spend behavior for cardholders during a second period into one of the plurality of classifications. The processing in step 306 corresponding to the second period takes place in the same manner as the processing described above for step 304 corresponding to the first period.

In step 308, the customer segmentation module 224c of the customer segment analysis server 200 compares the classification of the spend behavior in the first period with the classification of the spend behavior in the second period for each cardholder. The customer segmentation module 224c of the customer segment analysis server 200 associates the cardholder with one of a plurality of customer segments based on the result of this comparison.

In step 308, cardholders may be segmented as migrators if their spend increased between the first period and the second period such that the cardholder moved to a higher spend classification. This segmentation may be based on total spend in all categories or may alternatively be based on a certain number of spend categories. The cardholders may be classified as detractors if their spend decreased such that the cardholder moved to a lower spend classification between the first period and the second period. Cardholders remaining in the same classification for the first and second periods may be categorized as passive. An additional segment of new customers may be included to include new cardholders who joined during the second period.

The segmentation described above may be used to identify cardholders who are at early stages of attrition. Cardholders segmented as detractors may fall into this category. Similarly, cardholders in the migrator segment may be identified as having opportunities to increase engagement.

Once cardholders have been identified with segments as described above, marketing campaigns and strategies could be targeted to increase engagement with the customers or arrest attrition.

Whilst the foregoing description has described exemplary embodiments, it will be understood by those skilled in the art that many variations of the embodiment can be made within the scope and spirit of the present disclosure.

1. A computer implemented method of identifying customer segments from transaction data, the method comprising:
receiving, at a customer segment analysis server, transaction data, the transaction data comprising transaction indications, each transaction indication comprising an indication of a transaction date and a cardholder identifier;
classifying, in a spend behavior classification module of the customer segment analysis server, spending behavior of a cardholder in a first period into classifications from a plurality of classifications by analyzing transactions having a cardholder identifier matching the cardholder and a transaction date within the first period;
classifying, in the spend behavior classification module of the customer segment analysis server, spending behavior of the cardholder in a second period into classifications from a plurality of classifications by analyzing transactions having a cardholder identifier matching the cardholder and a transaction date within the second period; and
comparing, in a customer segmentation module of the customer segment analysis server, the classification of the spend behavior of the cardholder in the first period with the classification of the spend behavior of the cardholder in the second period and associating the cardholder with one of a plurality of customer segments based on a result of the comparison.

2. A method according to claim 1, further comprising identifying, in a spend category identification module of the customer segment analysis server, a spend category associated with each transaction, and wherein classifying spending behavior of the cardholder comprises classifying the spend behavior of the cardholder in each of a plurality of spend categories.

3. A method according to claim 2, the transaction indications further comprising a merchant identifier, and wherein identifying a spend category associated with a transaction comprises determining a merchant category associated with the merchant corresponding to the merchant identifier and using a mapping of merchant category to spend category to determine the spend category associated with the transaction.

4. A method according to claim 1, wherein the spend behavior classifications comprise ranges of total spend amount in the first and second periods.

5. A method according to claim 1, wherein the spend behavior classifications comprise ranges of number of transactions in the first and second periods.

6. A method according to claim 2, wherein the spend behavior classifications comprise ranges of spend amount in spend categories of the plurality of spend categories in the first and second periods.

7. A method according to claim 2, wherein the spend behavior classifications comprise ranges of number of transactions in spend categories of the plurality of spend categories in the first and second periods.

8. A non-transitory computer readable medium having stored thereon program instructions for causing at least one processor to:
receive, at a customer segment analysis server, transaction data, the transaction data comprising transaction indications, each transaction indication comprising an indication of a transaction date and a cardholder identifier;
classify, in a spend behavior classification module of the customer segment analysis server, spending behavior of a cardholder in a first period into classifications from a plurality of classifications by analyzing transactions having a cardholder identifier matching the cardholder and a transaction date within the first period;
classify, in the spend behavior classification module of the customer segment analysis server, spending behavior of the cardholder in a second period into classifications from a plurality of classifications by analyzing transactions having a cardholder identifier matching the cardholder and a transaction date within the second period; and
compare, in a customer segmentation module of the customer segment analysis server, the classification of the spend behavior of the cardholder in the first period with the classification of the spend behavior of the cardholder in the second period and associating the cardholder with one of a plurality of customer segments based on a result of the comparison.

9. An apparatus for identifying customer segments from transaction data, the apparatus comprising:
a computer processor and a data storage device, the data storage device having a spend behavior classification module, and a customer segmentation module comprising non-transitory instructions operative by the processor to:
receive transaction data, the transaction data comprising transaction indications, each transaction indication comprising an indication of a transaction date and a cardholder identifier;
classify spending behavior of a cardholder in a first period into classifications from a plurality of classifications by analyzing transactions having a cardholder identifier matching the cardholder and a transaction date within the first period;
classify spending behavior of the cardholder in a second period into classifications from a plurality of classifications by analyzing transactions having a cardholder identifier matching the cardholder and a transaction date within the second period; and
compare the classification of the spend behavior of the cardholder in the first period with the classification of the spend behavior of the cardholder in the second period and associate the cardholder with one of a plurality of customer segments based on a result of the comparison.

10. An apparatus according to claim 9, wherein the data storage device further comprises a spend category identification module comprising non-transitory instructions operative by the processor to identify a spend category associated with each transaction, and wherein classifying spending behavior of the cardholder comprises classifying the spend behavior of the cardholder in each of a plurality of spend categories.

11. An apparatus according to claim 10, wherein the transaction indications further comprise a merchant identifier, and wherein identifying a spend category associated with a transaction comprises determining a merchant category associated with the merchant corresponding to the merchant identifier and using a mapping of merchant category to spend category to determine the spend category associated with the transaction.

12. An apparatus according to claim 9, wherein the spend behavior classifications comprise ranges of total spend amount in the first and second periods.

13. An apparatus according to claim 9, wherein the spend behavior classifications comprise ranges of number of transactions in the first and second periods.

14. An apparatus according to claim 10, wherein the spend behavior classifications comprise ranges of spend amount in spend categories of the plurality of spend categories in the first and second periods.

15. An apparatus according to claim 10, wherein the spend behavior classifications comprise ranges of number of transactions in spend categories of the plurality of spend categories in the first and second periods.
